(19) United States
(12) Patent Application Publication
(10) Pub. No.: US 2006/0087526 A1
(43) Pub. Date: Apr. 27, 2006

(54) Method and system for monitoring operation of an ink jet print head using a micro-wire array

(75) Inventors: John E. Massucci, Eastchester, NY (US); Luis A. Sanchez, Hamden, CT (US)

Correspondence Address: Brian A. Lemm;Pitney Bowes Inc., 35 Waterview Drive, P.O. Box 3000, Shelton, CT, 06484, US

(73) Assignee: Pitney Bowes Incorporated, Stamford, CT (US)

(21) Appl. No.: 10/972,897

(22) Filed: Oct. 25, 2004

(51) Int. Cl. B41J 29/38

(52) U.S. Cl. 347/12

(57) ABSTRACT

Methods and systems to monitor the operation of ink jet print heads that are easy to implement and inexpensive are provided. The print head is positioned over an array of wires. The array of wires is heated, and the print head is controlled to eject droplets of ink from each nozzle of the print head onto a corresponding wire. Nozzles that are operating properly will eject droplets of ink, which will lower the temperature of the wire, thereby causing a change in resistance of the wire. Nozzles that are not operating properly will not eject droplets of ink, and therefore the resistance of the corresponding wires will remain constant. The resistance of each wire is monitored, and if a change in resistance in a wire is not detected, indicating that the ink droplets were not ejected onto that wire, a signal is generated that indicates a non-operational nozzle.

### FIELD OF THE INVENTION

The invention disclosed herein relates generally to printing systems, and more particularly to a method and system for monitoring the operation of an ink jet print head using a micro-wire array.

### BACKGROUND OF THE INVENTION

Low cost, widely available ink jet printing technologies have enabled many new applications where dynamically varying information must be transmitted in printed form. As used herein, the term “ink jet printing” refers to any form of printing wherein print control signals control a print mechanism to eject ink drops onto a medium to produce a matrix of pixels that represent an image. Many of these applications rely upon a consistent level of print quality over time since the failure to capture the unique information on even a single document can have serious consequences.

A particular example of an application of ink jet printing where a consistent level of print quality is very important is the use of digital print mechanisms in postage meters and mailing machines. Postage meters and mailing machines for printing postage indicia on envelopes and other forms of mail pieces have long been well known and have enjoyed considerable commercial success. There are many different types of mailing machines, ranging from relatively small units that handle only one mail piece at a time, to large, multi-functional units that can process thousands of mail pieces per hour in a continuous stream operation. The larger mailing machines often include different modules that automate the processes of producing mail pieces, each of which performs a different task on the mail piece. The mail piece is conveyed downstream utilizing a transport mechanism, such as rollers or a belt, to each of the modules. Such modules could include, for example, a singulating module, i.e., separating a stack of mail pieces such that the mail pieces are conveyed one at a time along the transport path, a moistening/sealing module, i.e., wetting and closing the glued flap of an envelope, a weighing module, and a metering module, i.e., applying evidence of postage to the mail piece. The exact configuration of the mailing machine is, of course, particular to the needs of the user.

Typically, a control device, such as, for example, a microprocessor, performs user interface and controller functions for the mailing machine. Specifically, the control device provides all user interfaces, executes control of the mailing machine and print operations, calculates postage for debit based upon rate tables, provides the conduit for the Postal Security Device (PSD) to transfer postage indicia to the printer, operates with peripherals for accounting, printing and weighing, and conducts communications with a data center for postage funds refill, software download, rates download, and market-oriented data capture. The control device, in conjunction with an embedded PSD, constitutes the system meter that satisfies U.S. information-based indicia postage meter requirements and other international postal regulations regarding closed system meters. The United States Postal Service (USPS) initiated the Information-Based Indicia Program (IBIP) to enhance the security of postage metering by supporting new methods of applying postage to mail. The USPS has published draft specifications for the IBIP. The requirements for a closed system are defined in the “Performance Criteria for Information-Based Indicia and Security Architecture for Closed IBI Postage Metering System (PCIBI-C), dated Jan. 12, 1999. A closed system is a system whose basic components are dedicated to the production of information-based indicia and related functions, similar to an existing, traditional postage meter. A closed system, which may be a proprietary device used alone or in conjunction with other closely related, specialized equipment, includes the indicia print mechanism.

The PCIBI-C specification defines the requirements for the indicium to be applied to mail produced by closed systems. An example of such an indicium is illustrated in FIG. 1. The indicium 10 consists of a two-dimensional (2D) barcode 12 and certain human-readable information 14. Some of the data included in the barcode can include, for example, the PSD manufacturer identification, PSD model identification, PSD serial number, values for the ascending and descending registers of the PSD, postage amount, and date of mailing. In addition, a digital signature is required to be created by the PSD for each mail piece and placed in the digital signature field of the barcode. Verification of indicium is performed by the postal service scanning a mail piece to read the 2D barcode and verifying the information contained therein, including the digital signature. If the verification is unsuccessful, indicating that the indicium may not be authentic, the mail piece may not be delivered.

Since postal services accept indicia printed by postage meters and mailing machines as conclusive proof of payment of the amount of postage indicated, such devices are in effect machines for printing money. As a result postal services have imposed high standards for the print quality of indicia images produced by such machines. Even if an indicium is valid, if the verification equipment is unable to read the indicium due to poor print quality, verification will not be possible. It is therefore necessary to ensure that the printing systems utilized by the mail processing systems are capable of consistently producing high quality images. Ink jet print mechanisms, however, are unable to provide consistent print quality as their mechanisms tend to degrade over time as ink dries up, small print nozzles clog, or one or more of a number of small, rapidly cycling print elements fails. Such a failure can cause substantial losses to a mailer since a large number of mail pieces of substandard print quality may be rejected by a postal service after the cost of the postage has been debited from the funds registers in the mailing machine.

Conventional systems for monitoring the operation of ink jet print heads require expensive imaging or scanning equipment and complicated signal processing techniques. While suitable for use to monitor the operation of ink jet print heads, such equipment is expensive, especially compared with the relatively low cost of available ink jet print heads, and can be very difficult to implement. Thus, there exists a need for a method and system that can monitor the operation of an ink jet print head that is inexpensive and easy to implement.

### SUMMARY OF THE INVENTION

The present invention alleviates the problems associated with the prior art and provides methods and systems to monitor the operation of ink jet print heads that are easy to implement and inexpensive.

In accordance with embodiments of the present invention, an array of wires is utilized to monitor the operation of an ink jet print head. The print head is positioned over the array, which preferably includes the same number of wires as there are nozzles in the print head, such that each nozzle is located above one of the wires. The array of wires is heated, and the print head is controlled to eject droplets of ink from each nozzle of the print head onto a corresponding wire. Nozzles that are operating properly will eject droplets of ink, which will lower the temperature of the wire when they make contact with the wire. The lowering of the wire temperature will cause a change in resistance of the wire. Nozzles that are not operating properly will not eject droplets of ink, and therefore the temperature of corresponding wires for non-operational nozzles will not be lowered, and the resistance will remain constant. The resistance of each wire is monitored, and if a change in resistance in a wire is not detected, indicating that the ink droplets were not ejected onto that wire, a signal is generated that indicates a non-operational nozzle. Remedial measures can then be taken to fix the non-operational nozzle or to inhibit further printing of postal indicia.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate a presently preferred embodiment of the invention, and together with the general description given above and the detailed description given below, serve to explain the principles of the invention. As shown throughout the drawings, like reference numerals designate like or corresponding parts.

FIG. 1 illustrates an example of an indicium that meets the IBIP specifications;

FIG. 2 illustrates in block diagram form a portion of a mail processing system including a station for monitoring the operation of the ink jet print head according to an embodiment of the present invention;

FIG. 3 illustrates in schematic block diagram form a device for monitoring the operation of the ink jet print head according to an embodiment of the present invention; and

FIG. 4 illustrates a cross sectional view of the device for monitoring operation of the ink jet print head.

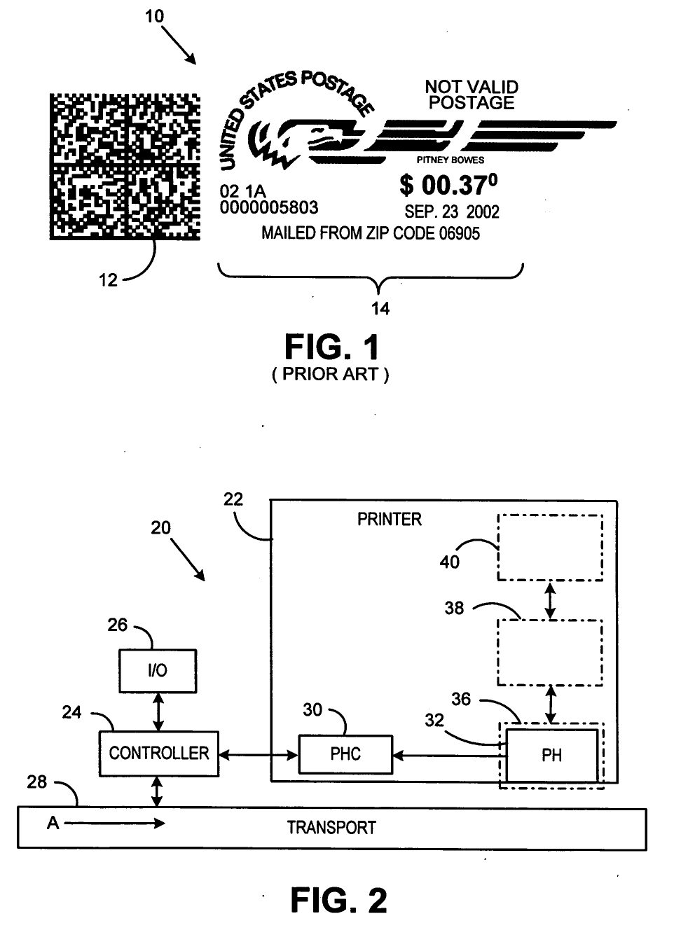

### DETAILED DESCRIPTION OF THE PRESENT INVENTION

In describing the present invention, reference is made to the drawings, wherein there is seen in FIG. 2 a portion of a mail processing system 20 according to an embodiment of the present invention. It should be noted that while the following description is being made with respect to a mail processing system, the present invention is not so limited and can be utilized in any type of ink jet printing system in which monitoring the operation of the ink jet print head is desired. Mail processing system 20 includes a controller 24, that preferably includes one or more controller units, such as, for example, a microprocessor, general or special purpose processor or the like, to control operation of the mail processing system 20. Controller 24 is coupled to one or more input/output devices 26, such as, for example, a keyboard and/or display unit for the input and output of various data and information. A printer 22, for printing postage indicia generated by the controller 24 on mail pieces, is coupled to controller 24. A transport 28, including, for example, rollers and/or belts, is utilized to transport mail pieces through the mail processing system 20 in the direction indicated by arrow A based on signals provided from the controller 24. The transport 28 will transport the mail pieces past the printer 22 such that printing can occur on each mail piece.

Printer 22 includes a print head controller (PHC) 30 that is coupled to the controller 24. PHC 30 controls the operation of a print head (PH) 32. The PHC 30 can cause the print head 32 to move between a plurality of positions, including, for example, a printing position 36 (as illustrated in FIG. 2), a capped position 38, and according to an embodiment of the invention, a test position 40. Only when the print head 32 is in the printing position 36 is printing possible. If the print head 32 is in the capped position 38, the print head 32 cannot print. Thus, when printer 22 is not being requested to print, the PHC 30 will send signals to the print head 32 instructing the print head 32 to move into the capped position 38, thereby protecting the nozzles of the print head from damage as well as preventing them from becoming clogged by ink drying within the nozzle. It should be noted that the print head 32 may also be moved into other positions, such as a maintenance position, during which maintenance operations can occur.

According to embodiments of the present invention, PHC 30 will periodically move the print head 32 to the test position 40 to monitor the operation of the print head 32 to ensure that all nozzles are operating correctly. For example, a monitoring operation could be performed on a periodic basis based upon a number of mail pieces processed, e.g., every fifty mail pieces. Alternatively, a monitoring operation could also be performed as part of a standard print head maintenance routine.

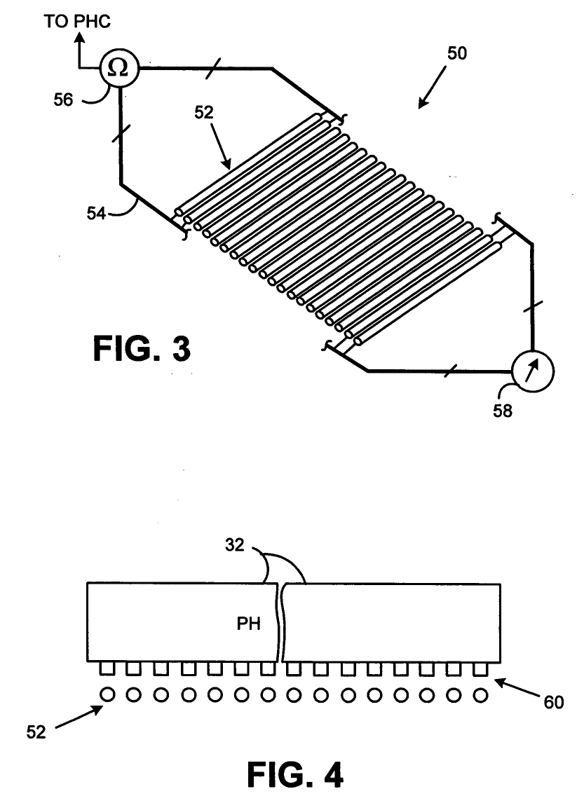

Referring now to FIG. 3, there is illustrated in schematic block diagram form a device 50 for monitoring the operation of the ink jet print head 32 according to an embodiment of the present invention. The device 50 is located in the test position 40 such that the print head 32, when moved into the test position 40, will be over the device 50. Device 50 includes an array of n wires 52, where the number of wires n included in the array is preferably at least as large as the number of nozzles in the print head 32. The wires in the array 52 are preferably formed from a material whose change in resistance when subjected to a temperature differential can be easily detected or measured. One example of such a wire is nichrome wire, the resistivity of which changes with temperature at about 0.0002 Ohms/° C. Thus, for a temperature change of 100° C., the resistivity will change by approximately 20 milliohms, which can be easily detected by conventional resistance detection circuits.

The wires also preferably have a small enough diameter such that (i) each wire in the array 52 will align with a corresponding nozzle in the print head 32; and (ii) it does not require a large amount of ink droplets from each nozzle to cause a sufficient temperature change in each wire to change the resistance of the wire significantly enough to be detected. To satisfy the second requirement, it is preferable to select a diameter of wire based on the size of each drop such that the wire will be coated with only a few drops. Thus, the diameter of the wire is preferably selected based on the diameter of each drop of ink. Assuming that each ink droplet is a sphere, the diameter, D, of each droplet can be calculated from the following formula:
D=(6 V/π)^{1/3}
where V is the volume. The volume of each drop is approximately 20 picoLiters (1.22×10⁻⁹ in³). Thus, using the above equation, the diameter of each drop is approximately 0.0013 in. Based on the diameter of each drop being approximately 0.0013 inches, a suitable diameter for each wire is approximately 0.002 inches. This will allow each wire to be surrounded by ink with relatively few droplets. If the ink droplets arrive at a frequency of 14 kHz, the wire will be surrounded by ink within a time frame in the order of microseconds. It should be understood, of course, that the above description is exemplary in nature only and other types and diameters of wire can also be used.

The wire array 52 is coupled, by, for example, a bus 54, to a resistance measuring device 56, such as, for example, a Wheatstone Bridge circuit, or any other type of suitable device that can either measure the actual resistance or detect changes in resistance of each of the wires in the array 52. While only a single device 56 for all of the wires in the array 52 is illustrated in FIG. 3, it should be understood that more than one device 56 may be provided. The array 52 is also coupled to a current source 58 to pass current through each of the wires in the array 52. Current source 58 can be any type of device capable of passing current through each of the wires in the array 52.

The operation of the device 50 is as follows. When it is desired to monitor the operation of the print head 32, the PHC 30 moves the print head 32 to the test position 40. FIG. 4 illustrates a cross sectional view of the print head 32 positioned above the array 52 of the device 50. Each of the nozzles 60 of the print head 32 is aligned with a corresponding wire of the array 52. The current source 58 is activated, and current passed through each of the wires in the array 52, thereby heating the wires. It should be noted that any method can be used to heat the wires. The wires are preferably heated to a temperature of approximately 260-300° C. PHC 30 will then provide control signals to the print head 32, which in response will fire each of the nozzles 60 to expel ink from each of the nozzles 60. The firing of the nozzles 60 can occur simultaneously for all of the nozzles 60, or alternatively each nozzle 60 can be fired separately in succession, or alternatively subset groups of the nozzles 60 can be fired in succession, with each of the nozzles 60 in a specified subset group being fired simultaneously.

For those nozzles 60 that are operating properly, upon firing ink will be expelled from the nozzle 60 and deposited onto the corresponding wire of the array 52. The ink droplets making contact with the wires will cause the temperature of the heated wires to decrease, which in turn will cause a corresponding change in resistance of the wires. For those nozzles 60 that are not operating properly, e.g., the nozzle is clogged, a print element has failed, etc., upon firing ink will not be expelled from the nozzle 60 and therefore no ink will be deposited onto the corresponding wire of the array 52. The temperature of the wires where no ink is deposited will remain relatively constant, and therefore there will be no change in resistance of the wires where no ink is deposited. The resistance of the wires is monitored by the resistance measuring device 56. If no change of resistance is measured for a wire in the array 52, a signal is sent to the PHC 30 indicating that a nozzle 60 is not operating properly. PHC 30 can then take remedial measures to try and correct the problem that is causing the nozzle to be inoperative, such as, for example, by performing a nozzle cleaning operation. Alternatively, the PHC 30 can provide a signal to the controller 24 indicating that one or more of the nozzles 60 in the print head 32 are not operating properly, and controller 24 in response can inhibit further printing. Optionally, the PHC 30 can receive a separate signal for each nozzle 60 of the print head 32, and only after some predetermined minimum number of nozzles 60 are determined to be inoperative will some remedial action be taken or the controller 24 notified of the inoperative nozzles.

Thus, methods and systems to monitor the operation of ink jet print heads that are easy to implement and inexpensive are provided. The print head is positioned over an array of wires. The array of wires is heated, and the print head is controlled to eject droplets of ink from each nozzle of the print head onto a corresponding wire. Nozzles that are operating properly will eject droplets of ink, which will lower the temperature of the wire when they make contact with the wire. The lowering of the wire temperature will cause a change in resistance of the wire. Nozzles that are not operating properly will not eject droplets of ink, and therefore the temperature of corresponding wires for non-operational nozzles will not be lowered, and the resistance will remain constant. The resistance of each wire is monitored, and if a change in resistance in a wire is not detected, indicating that the ink droplets were not ejected onto that wire, a signal is generated that indicates a non-operational nozzle.

While preferred embodiments of the invention have been described and illustrated above, it should be understood that these are exemplary of the invention and are not to be considered as limiting. Those skilled in the art will also recognize that various modifications can be made without departing from the spirit of the present invention. For example, the number of wires n in the array of wires 52 can be less than the number of nozzles 60 in the print head 32, and the array 52 (or the print head 32) can be moved to position each of the nozzles 60 over a wire in the array 52 at some point for testing. Thus, a single wire can be used with more than one nozzle 60, or even a single wire can be used for every nozzle 60. Therefore, the inventive concept in its broader aspects is not limited to the specific details of the preferred embodiments but is defined by the appended claims and their equivalents.

What is claimed is:

1. A method for monitoring operation of an ink jet printing mechanism including a plurality of print nozzles, the method comprising:
moving the ink jet printing mechanism such that a nozzle is aligned with a wire;
heating the wire;
attempting to fire the nozzle aligned with the wire to expel ink onto the wire;
monitoring resistance of the wire; and
if the resistance of the wire does not change, generating a signal indicating the nozzle is non-operational.

2. The method of claim 1, wherein moving the ink jet printing mechanism further comprises:
moving the ink jet printing mechanism such that each of a portion of the plurality of nozzles are aligned with a corresponding wire in a wire array.

3. The method of claim 2, wherein attempting to first the nozzle further comprises:
attempting to fire the portion of the plurality of nozzles to expel ink onto respective corresponding wires of the wire array.

4. The method of claim 3, wherein the portion of the plurality of nozzles are attempted to be fired simultaneously.

5. The method of claim 3, wherein the portion of the plurality of nozzles are fired separately in succession.

6. The method of claim 1, wherein heating the wire further comprises:
passing current through the wire.

7. The method of claim 1, wherein heating the wire further comprises:
heating the wire to a temperature of approximately 260-300° C.

8. The method of claim 1, wherein the wire is a nichrome wire.

9. An apparatus for monitoring operation of an ink jet printing mechanism having a plurality of print nozzles, the apparatus comprising:
a controller to control firing of the plurality of print nozzles and movement of the ink jet printing mechanism between a printing position and a testing position;
an array of wires located beneath the testing position, such that when the ink jet printing mechanism is in the testing position, a portion of the plurality of nozzles is aligned with respective corresponding wires of the array;
means for heating the array of wires; and
means for monitoring resistance of each wire in the array of wires.

10. The apparatus of claim 9, wherein the array of wires are nichrome wires.

11. The apparatus of claim 9, wherein the means for heating the array of wires further comprises:
a current source coupled to pass current through the array of wires.

12. The apparatus of claim 9, wherein each wire of the array of wires has a diameter of approximately 0.002 inches.

13. A mailing machine comprising:
a transport to pass mail pieces through the mailing machine;
an ink jet printing device adapted to print on the mail pieces being transport by the transport device, the printing device comprising:
a print head having a plurality of print nozzles;
a controller to control firing of the plurality of print nozzles and movement of print head between a printing position and a testing position;
an array of wires located beneath the testing position, such that when the print head is in the testing position, a portion of the plurality of nozzles is aligned with respective corresponding wires of the array;
means for heating the array of wires; and
means for monitoring resistance of each wire in the array of wires.

14. The mailing machine of claim 13, wherein the array of wires are nichrome wires.

15. The mailing machine of claim 13, wherein the means for heating the array of wires further comprises:
a current source coupled to pass current through the array of wires.

16. The mailing machine of claim 13, wherein each wire of the array of wires has a diameter of approximately 0.002 inches.
